(19) United States
(12) Patent Application Publication
(10) Pub. No.: US 2021/0078912 A1
(43) Pub. Date: Mar. 18, 2021

(54) CERAMIC SANITARY ARTICLE AND METHOD FOR PRODUCING SAME

(71) Applicant: Duravit Aktiengesellschaft, Hornberg (DE)

(72) Inventors: Thomas STAMMEL, Hornberg (DE); Christian GILLES, Offenburg (DE)

(21) Appl. No.: 17/023,512

(22) Filed: Sep. 17, 2020

(30) Foreign Application Priority Data
Sep. 18, 2019 (DE) 10 2019 125 139.6

(51) Int. Cl. C04B 40/00; C04B 41/86; C04B 41/53

(52) U.S. Cl. CPC C04B 40/0075; C04B 41/53; C04B 41/86

(57) ABSTRACT

A method for producing a ceramic sanitary article, more particularly a washbasin or washstand, wherein a mold is used to produce, from a ceramic composition, a green body, which is subsequently fired in a firing to form a fired body, where the fired body after the firing is subjected to material-removing working on one or more visible faces until it has a desired dimension, after which the worked body is glazed at least on the worked visible face or faces and is fired a further time in order to fire the glaze.

### CROSS-REFERENCE TO RELATED APPLICATIONS

The present application claims priority of DE 10 2019 125 139.7, filed Sep. 18, 2019, the priority of this application is hereby claimed and this application is incorporated herein by reference.

### BACKGROUND OF THE INVENTION

The invention relates to a method for producing a ceramic sanitary article, more particularly a washbasin or washstand, wherein a mold is used to produce, from a ceramic composition, a green body, which is subsequently fired in a firing to form a fired body.

A variety of forms of such sanitary articles are known, examples being washbasins or washstands, and also shower bases or trays, WCs, bidets, etc. These are ceramic articles, with the term “ceramic” presently being understood to include porcelain-based sanitary articles as well. An article of this kind is produced typically in a casting process, which takes place either in a plaster cast or in a pressure cast with polymeric molds. After the ceramic casting composition has been made up, it is introduced into the appropriate casting mold, where it remains for a time and forms a green body, which still has a high water content. A glaze is then applied to the dried green body, at least on those faces which are visible when the sanitary article is in its installed position; for this purpose, a corresponding glaze composition is usually sprayed on. The green body is subsequently fired, with the effects of expelling the water and giving the fired body its strength, and also of firing the glaze and giving it its luster. The production route of a ceramic sanitary article of this kind is well known.

During the firing, the body shrinks, resulting from the loss of water and from the sintering of the ceramic composition. This shrinkage may show considerable extents, with the shrinkage process differing from body to body, because the corresponding events proceed in a slightly different way in the individual bodies, in other words when producing separate sanitary articles. This means that during the firing, there is a corresponding deformation of the body and, accordingly, each body, and hence also the subsequent sanitary article after the firing exhibits a certain tolerance. Based on the width and the protrusion of the sanitary article—of a washstand, for example—this tolerance is around +/−1%. In the case of a washstand 1000 mm wide, this means a tolerance of +/−1 cm from washstand to washstand. Based on the deformation, there are tolerances of up to 5 mm on the protrusion. This means that, accordingly, in accordance with the manufacture of ceramic articles, there are considerable geometric or dimensional differences between sanitary articles produced within a batch or over several batches, and this, of course, is undesirable.

In relation to curvature, furthermore, there are technological limits in terms of a minimum curvature radius at transitions from planar faces, as for example at edges of a washstand, and these limits must be observed, since otherwise there are excessive stresses and, consequently, cracking. The minimum possible radius is, for example, around 7 mm in the case of fine fire clay and around 5 mm in the case of a high-strength composition. Here as well there are restrictions, and, of course, in the area of the radius which forms as well, there are shrinkage-related tolerances over a number of sanitary articles.

### SUMMARY OF THE INVENTION

The problem addressed by the invention, therefore, is that of specifying a method improved accordingly that enables the production of sanitary articles with dimensional integrity.

To solve this problem, in a method of the aforementioned kind, in accordance with the invention, the fired body after the firing is subjected to material-removing working on one or more visible faces until it has a desired dimension, after which the worked body is glazed at least on the worked visible face or faces and is fired a further time in order to fire the glaze.

The method of the invention provides for a two-stage firing, where between the first firing and the second firing there is material-removing working of the body fired in the first firing, followed by a glaze coating and a second firing. After the casting and drying of the body, the body, in either unglazed, partly glazed or completely glazed form—this will be addressed more below—is fired in a first firing. As a result, the substances which need to be expelled, such as water, carbon dioxide, organic auxiliaries, etc., are expelled and the ceramic composition sinters. Within this first firing, the above-described shrinkage and deformation events occur, and within this first firing are concluded completely or almost completely.

After the first firing has been carried out, accordingly, the result is a quasi-fully fired body or sanitary article which, however, as described above, exhibits geometric tolerances of considerable magnitude.

In the next step, then, this fired article is subjected to material-removing working on one or more visible faces, these being faces which in the installed position are viewable, i.e., exposed; material-removing working means that the article is worked, for example, by milling or grinding, with removal of fired material, on the visible face or faces, until it has a desired dimension. This means that in this step the body is worked to an exact, desired dimension in respect of length, width, height, protrusion, edge radius, etc.

In the next step, then, either for the first time or a second time, a glaze is applied, at least to the worked visible faces, this typically being accomplished by sprayed application of the glazing composition. The sanitary article or body already fired a first time is subsequently fired a second time in order to fire the glaze. During this firing, then, since the ceramic composition has already been fired and is therefore sintered and since the shrinkage and deformation events have been concluded already very largely or completely in the first firing, there are no further notable shrinkage or deformation events, meaning that in the second firing, the sanitary article which has already been fired once retains its shape and dimensions. There is only firing of the glaze, but there are no further sintering events within the ceramic material. The sanitary article then fully fired in the second firing therefore has exactly the desired dimensions in every direction that it is intended to have. Trials have shown that in relation to the length and width dimension of a washstand, for example, at a length of 1000 mm, for example, the deviation from the target dimension is around +/−0.3 mm, while in relation to the washstand width, in the case of a target width of 450 mm, a tolerance of around +/−0.2 mm has been established.

Accordingly, the method of the invention allows the production of any desired number of sanitary articles with extremely high dimensional integrity, meaning that each fully fired sanitary article ultimately has identical dimensions, in terms not only of length, width, and height dimensions but also of any radii at curvatures and the like.

According to one advantageous development of the invention, the firing temperature during the second firing is lower than the firing temperature in the first firing. Since in the second firing it is only the glaze that is to be fired, and this can also take place at somewhat lower firing temperatures than for the firing of the ceramic composition, it is possible, through a somewhat lower firing temperature in the second firing, to rule out even any such slight further shrinkage. In this context, the firing temperature in the second firing ought to be around 10-100° C., more particularly around 15-60° C., and preferably around 20-40° C. lower, and the firing temperature in the first firing can be between 1200-1300° C., more particularly 1240-1290° C.

Since, as described, the subject of the second firing is only the glaze, it is also possible for the holding time during the second firing to be shorter than the holding time during the first firing. This is because the glaze coating is extremely thin, being around 0.9 mm, and it is applied very uniformly. This means that this thin glaze coating also fires relatively quickly to a glasslike, impervious surface layer, and hence the holding time during the second firing can be much shorter than in the first firing. The holding time in the second firing is preferably shorter by 90-110 min, more particularly by 100 min, than in the first firing, and the holding time during the first firing can be, for example, between 240-360 min, more particularly between 250-350 min. A shorter holding time is, however, only optional; provision may also be made for a comparable holding time or else a somewhat longer holding time than in the first firing.

A central step in the method of the invention is the material-removing working, on one or more visible faces, of the body fired in the first firing. This removal of material is accomplished preferably by milling using a suitable milling tool, with the milling tool being moved preferably under robot control in order to achieve the high-precision removal of material. The milling tool is guided for example via a 5-axis robot, which enables any desired movement of the milling tool in space, hence allowing any desired face geometries to be worked. An alternative option to the milling that is also conceivable is a removal of material by grinding, with this working being suitable especially for relatively large, planar faces. Using such a milling tool or profile miller, especially in conjunction with the robot, therefore, it is possible to generate virtually any desired geometries—for example, planar faces, angular structures, undulating faces or wave structures, or in particular, curvatures in the region of corners with large radii of several centimeters, although, as elucidated below, these curvatures may also have very small radii.

According to one advantageous development of the invention, the material-removing working takes place in such a way that edges on the sanitary article after the second firing have a radius ≤2 mm, more particularly ≤1 mm. A further advantage of the method of the invention becomes apparent here, since the method makes it possible to form edges with a minimum radius. Ultimately, indeed, it is possible for the edge radius to be determined only by the layer thickness of the glaze fired in the second firing procedure. Where, for example, the sanitary article, i.e., the washstand or the washbasin, has two visible faces extending at 90° to one another and converging at an edge, the material-removing working may take place in such a way that the edge is formed as a sharp 90° edge, which therefore has no radius. Where the visible faces and hence also the edge are then covered with the glazing composition, and this composition is fired, a minimum radius is formed at the edge only by virtue of the extremely thin glaze layer, having a thickness of around 0.9 mm, and this radius, depending on glaze thickness, may also be <1 mm. Hence it is possible to form very exact edges, having only minimal curvatures, at the convergence of two visible faces, which may be at any desired angle to one another, hence including angles of less than or greater than 90°. The edges may be formed, or more particularly generated by milling, at any desired locations on the sanitary article.

As already described early on, the possibility exists of firing an unglazed body in the first firing and, after working of the corresponding visible faces, of glazing the already once-fired body and subsequently firing it a second time. Conversely, however, a useful configuration of the method provides for a glaze to be applied to the body at least locally, optionally also over the full area of all visible faces, before the first firing, with this glaze being fired in the first firing. The glaze in this case may be applied either only to visible faces which are subsequently not worked mechanically, or may be applied over the full area of all visible faces, so that during the mechanical working the glaze is removed at least on the visible faces that are to be worked, and these working visible faces are then glazed a second time. The advantage of a glaze coating even before the first firing is that the body which has only been dried, but not as yet fired, absorbs a large amount of water from the glaze coating, since the body exhibits high absorbency. This makes it easier to spray on the glaze and to form a uniform spray pattern. Nevertheless, as described, the partial or complete glazing before or in the first firing is not absolutely necessary.

If, however, a first glaze of this kind is applied, either only locally or over the full area, then the mechanical working takes place after the first firing; in the course of this mechanical working, only unglazed visible faces are worked, in the case of partial glazing, for example, or else visible faces that have already been glazed are worked with removal of the glaze, in the case of more extensive or full glazing. In any case, before the second firing, the worked visible faces must be glazed, i.e., sprayed with the glaze composition, with this application of glaze taking place in such a way as to produce a uniform, stepless transition to the face that has already been glazed.

As well as the method of the invention, the invention further relates to a ceramic sanitary article produced by the method. This article is notable for an extremely high dimensional integrity, in length, width and/or height, according to the extent to which or, respectively, which visible faces have undergone corresponding mechanical working, and it also has high-precision edges and possibly minimum radii as well. In particular, this extremely high dimensional integrity is maintained over an arbitrarily large number of the same sanitary articles produced.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawing:

FIG. 1 shows a schematic representation to illustrate the method of the invention,

FIG. 2 shows a partial view of a sanitary article of the invention after the first firing and after implementation of the mechanical working, and

FIG. 3 shows a sectional view through the sanitary article of the invention from FIG. 2, in the edge region.

### DETAILED DESCRIPTION OF THE INVENTION

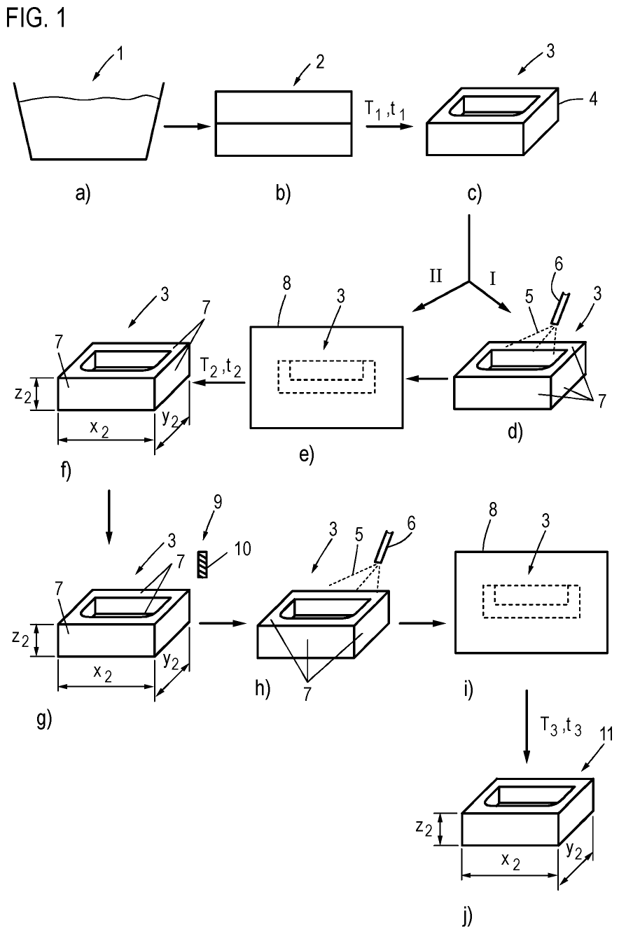

FIG. 1 shows the process of the method of the invention, in the form of a flow diagram.

First of all in step a), a castable ceramic composition 1 is prepared, which then—see step b)—is introduced into a plaster or pressure casting mold 2, where it remains for a certain time to form a green ceramic body which, after removal from the mold 2, is dried for a defined first time t₁ at a defined temperature T₁, so that—see step c)—a dried green body 3 is formed, here by way of example in the form of a washstand or washbasin 4.

At this point, there are two variant methods, represented using the arrows I and II. According to variant I, the green body 3 can be covered with a glaze composition 5, using a suitable spraying facility 6 in order to apply the glaze composition 5 to one or more of the visible faces 8 of the green body 3. This is shown in step d). Following application of this glaze, the glaze-coated green body 3—see step e)—is introduced into a firing oven 9 in order for it and the spray-applied glaze composition 5 to be fired.

According to variant II, after the drying of the green body 3, for the formation of a fired body 7, the merely dried but not glaze-coated is introduced directly into the firing oven 9 in step c), meaning that in this case the unglazed green body 3 is fired in step e).

The green body 3, whether unglazed or (partly) glazed, is fired in the firing oven 9 for a predetermined time t₂ at a predetermined firing temperature T₂, with the time t₂, the so-called holding time, being between 240-360 min, more particularly between 250-350 min. The firing temperature during this first firing is between 1200-1300° C., more particularly between 1240-1290° C.

Following implementation of the firing operation, the fired body 7 is withdrawn from the firing oven 9 and cooled, this being shown in step f). After the firing, the body 7 has altered dimensions in comparison to the merely dried green body according to step c), owing to shrinkage and deformation events concluded in the course of the firing. After the first firing, by way of example, the body 7 has a length x₁, a width y₁, and a height z₁. Here, as described, the visible faces 8 may be either unglazed or glazed, depending on whether variant I or II has been implemented.

In the next step, g), the fired body 7 is subjected to material-removing working by means of a tool 10, preferably a miller 11, which can be moved in space via a multi-axis robot, more particularly a 5-axis robot, in the region of one or more or all visible sides 8, which are therefore viewable by the user in the installed position; this working takes place until the body has a predetermined target dimension in the respective desired direction. After this material-removing working, by way of example, the body 7 has a length x₂, a width y₂, and a height z₂, the surfaces here being assumed to have been worked in each dimension. In other words, x₂<x₁, y₂<y₁, and z₂<z₁. It is, however, not necessary for each dimension to be worked; instead, it is also possible for only some of the dimensions to be worked, according to the direction in which a high-precision dimensional integrity is desired. Through the working of the visible faces 8, in the course of which, if a glaze has already been applied, this glaze as well has been removed at least on parts of the visible faces 8, where, indeed, the material working takes place, therefore the fired body 7 is worked in such a way that it has the desired final target dimensions.

In the next step, h), the worked body 7, optionally again, is glazed on either all the visible faces 8 or, if an initial glaze has already taken place, on the visible faces 8 worked in step g), this glazing meaning that a glaze composition 5 is (re-)applied by spraying using a spraying tool 6. The body 7 glaze-coated accordingly is then introduced again into the or a firing oven 9 (step i)), where it is fired a second time. This is done at a firing temperature T₃ which is somewhat lower than the firing temperature T₂ during the first firing. The firing temperature T₃ ought to be lower by around 10-100°, more particularly by 15-60° C., and preferably by 20-40°.

The holding time ta as well, being the duration for which the second firing takes place, is shorter than the holding time t₂ in the first firing. The holding time t₃ ought to be shorter by 90-110 min, more particularly by around 100 min, than the holding time t₂.

The reduction in the firing temperature T₃ is of advantage insofar as it results in definitive avoidance of the slightest shrinkage events and hence deformation events during this second firing—these events, as described, are already concluded within the first firing. The reduced firing temperature in the second firing avoids even only minimal alterations in the target dimensions x₂, y₂, and z₂ produced by mechanical working, apart from the minimal increase as a result of the glaze layer, which is very thin and usually less than 1 mm thick. The reduced holding time is set because the only task in this second firing is to fire the thin glaze layer, which is rapidly accomplished.

Following implementation of the second firing, the ceramic sanitary article 12, which is then fully fired and glazed, is withdrawn from the firing oven 9, as shown in step j). Since no further deformations have occurred during the second firing, this article continues to have the target dimensions x₂, y₂, and z₂ produced by the mechanical working in step g), with these dimensions having not undergone significant change—only through the applied glaze layer, which, as described, has a thickness of less than 1 mm. This means that the completed sanitary article 12 has exactly the desired target dimensions and, accordingly, does not suffer from tolerance, and can be manufactured reproducibly with exactly these dimensions, hence any desired number of sanitary articles 12 can be produced with the same target dimensions.

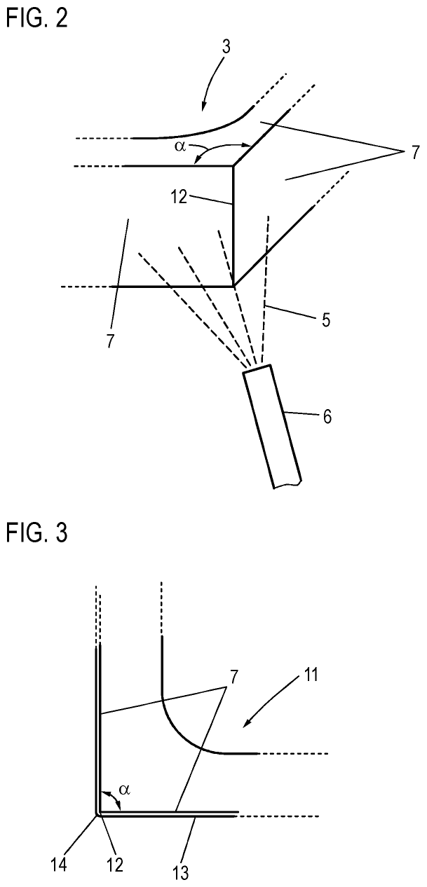

FIG. 2 shows a partial view of the body 7, already fired once, after implementation of the material-removing working according to step g). It may be assumed that the visible faces 8 which converge in the region of the left-hand front edge 13 have been worked. It may further be assumed that the edge 13 and, respectively, the adjacent, right-hand and left-hand visible faces 8 are at an angle α of 90° to one another; in this regard, see also the sectional view according to FIG. 3. As shown in FIG. 2, the glaze composition 5 is applied via the spraying facility 6 to the milled visible faces 8, and then fired in the second firing (step i)).

FIG. 3 shows a sectional view through the fully fired ceramic sanitary article 12. Shown again is the still sharp edge 13 at the convergence of the two visible faces 8, which still approach one another exactly at the angle α=90°. Additionally shown is the fired glaze layer 14, which is extremely thin and has a thickness of typically less than 1 mm, but which is shown here somewhat thicker for reasons of illustration. In any case, only a minimum radius 15 of the glaze layer 14 is formed at the edge 13, meaning that at this edge of the fired sanitary article 12, a curvature with a minimum radius is obtained, this curvature being ultimately dependent in its radius only on the layer thickness of the glaze coating 14. By virtue of the mechanical working of the bordering visible faces 8, the formation of the edge or the edge radius is no longer material-dependent, since with existing customary production methods, in order to avoid cracking, the only edges it has been possible to form are not sharp edges but rather edges with a radius of several millimeters.

Such an edge may be provided at any desired position on the sanitary article—for example, at the convergence of two side faces, or in the region of a top-face recess for accommodating one or more fittings or a soap tray, etc.—anywhere, that is, where two (planar) faces approaching at an angle converge with one another. In addition to very small radii and/or sharp edges, it is of course possible, with the appropriate milling tool or profile miller, to also generate curvatures with larger radii, in the centimeter range, for example, which then undergo only insubstantial enlargement with the glaze.

As well as the production of a sanitary article having extremely high dimensional integrity in a desired spatial direction, therefore, the method of the invention also enables, furthermore, the formation of any desired edges or convergences with a varying radius; in other words, it is possible to form high-precision curvatures by corresponding mechanical working of the face convergences, and also to form edges with a smaller radius, down to edges with a minimum radius of 1 mm or less.

While specific embodiments of the invention have been shown and described in detail to illustrate the inventive principles, it will be understood that the invention may be embodied otherwise without departing from such principles.

We claim:

1. A method for producing a ceramic sanitary article, more particularly a washbasin or washstand, wherein a mold is used to produce, from a ceramic composition, a green body, which is subsequently fired in a firing to form a fired body, wherein the fired body after the firing is subjected to material-removing working on one or more visible faces until it has a desired dimension, after which the worked body is glazed at least on the worked visible face or faces and is fired a further time in order to fire the glaze.

2. The method according to claim 1, wherein the firing temperature in the second firing is lower than the firing temperature in the first firing.

3. The method according to claim 2, wherein the firing temperature in the second firing is lower by 10-100° C., more particularly by 15-60° C., preferably by 20-40° C.

4. The method according to claim 1, wherein the firing temperature in the first firing is 1200-1300° C., more particularly 1240-1290° C.

5. The method according to claim 1, wherein a holding time during the second firing is shorter than a holding time during the first firing.

6. The method according to claim 5, wherein the holding time in the second firing is shorter by 90-110 min, more particularly by 100 min.

7. The method according to claim 1, wherein the holding time in the first firing is 240-360 min, more particularly 250-350 min.

8. The method according to claim 1, wherein the material-removing working takes place by milling or grinding.

9. The method according to claim 1, wherein the material-removing working takes place in such a way that edges on the sanitary article after the second firing have a radius ≤2 mm, more particularly ≤1 mm.

10. The method according to claim 1, wherein before the first firing, at least locally, a glaze is applied to the body and is fired in the first firing.

11. The method according to claim 10, wherein the glaze is also applied to the one or more visible faces intended for subsequent working, where it is removed in the course of the working, and the visible face(s) are subsequently reglazed.

12. A ceramic sanitary article produced by the method according to claim 1.
